(19) United States
(12) Patent Application Publication
(10) Pub. No.: US 2023/0138470 A1
(43) Pub. Date: May 4, 2023

(54) PACKAGING MATERIAL PRODUCTION MACHINE AND DIVERTER

(71) Applicant: Sprick GmbH Bielefelder Papier- und Wellpappenwerke & Co., Bielefeld (DE)

(72) Inventors: Bastian Schalk, Detmold (DE); Vitali Krebs, Ahlen (DE)

(73) Assignee: Sprick GmbH Bielefelder Papier- und Wellpappenwerke & Co., Bielefeld (DE)

(21) Appl. No.: 17/786,793

(22) PCT Filed: Dec. 10, 2020
(86) PCT No.: PCT/EP2020/085534

§ 371 Date: Nov. 18, 2022

(30) Foreign Application Priority Data
Dec. 20, 2019 (DE) 10 2019 135 629.6

(51) Int. Cl. B31D 5/00

(52) U.S. Cl. CPC B31D 5/0039; B31D 2205/0029; B31D 2205/0035; B31D 2205/0047; B31D 2205/0082

(57) ABSTRACT

A packaging material production machine for manufacturing a packaging material product may include a feed funnel for introducing packaging material from a web-shaped packaging material supply into the packaging material production machine, and a deflection shaft supported rotatably in a free-wheeling manner on the packaging material production machine for introducing the packaging material into the feed hopper. The deflection shaft may include lateral end portions whose diameters continuously increase outwardly at least in sections. The packaging material may be in the form of a leporello stack or in roll form.

### CROSS REFERENCE TO RELATED APPLICATIONS

This patent application is a U.S. National Stage Application of PCT/EP2020/085534, filed Dec. 10, 2020, which claims priority to German Patent Application No. 102019135629.6, filed Dec. 20, 2019, each of which is incorporated herein by reference in its entirety.

### BACKGROUND

### Field

The present disclosure relates to a packaging material production machine for producing a two-dimensional or three-dimensional packaging material product from a packaging material supply which is provided, for example, in the form of a leporello stack or in roll form and may comprise paper, cardboard, or the like, in particular recycled paper and/or 100% recyclable recycled paper without chemical ingredients. Furthermore, the present disclosure relates to a deflection device for introducing packaging material from a web-shaped packaging material supply, provided for example in the form of a leporello stack or in roll form, into a packaging material production machine.

### Related Art

Generic packaging material production machines usually comprise a receiving device for the packaging material supply, a feed funnel for introducing the packaging material into a forming device which serves to form the web-shaped packaging material into two-dimensional or three-dimensional packaging material products. This may be followed by a delivery and/or cut-to-length device.

AU2011/202898B2 discloses a packaging machine with a deflection device arranged upstream of a feed funnel. The supply of packaging material is provided, for example, in leporello form and is always stored in the immediate vicinity of the packaging machine. The packaging machine can, for example, have a support for depositing the supply stack. Via the deflection device, the web-shaped packaging material is at least partially guided in the direction of the feed funnel. The deflection device may, for example, be configured as a free-wheeling substantially cylindrical shaft having end portions at its lateral ends, at which the deflection shaft is supported, the diameters of which end portions continuously decrease outwardly. In another embodiment, AU2011/202898B2 discloses a deflection rod that is stationarily mounted on the packaging machine and has a substantially triangular cross-section.

A disadvantage of both versions of the deflection device is that it is necessary to position the packaging material supply at the position provided on the packaging machine to ensure safe insertion into the feed funnel.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 is a perspective view of a packaging material production machine according to an exemplary embodiment of the disclosure.

FIG. 2 is a detailed view II according to FIG. 1.

FIG. 3 is a top view of a feed funnel, according to an exemplary embodiment of the disclosure, of the packaging material production machine of FIG. 1.

FIG. 4 is a sectional view according to line IV-IV according to FIG. 3.

FIG. 5 is a top view of the packaging material production machine of FIG. 1, according to an exemplary embodiment of the disclosure.

FIG. 6 is a side view of the packaging material production machine according to FIGS. 1-5 and a packaging material supply, according to an exemplary embodiment of the disclosure.

FIG. 7 is a front view with respect to FIG. 6.

FIG. 8 is a perspective view of a packaging material production machine and of a packaging material supply, according to exemplary embodiments of the disclosure.

FIG. 9 is a schematic top view with respect to FIG. 8.

FIG. 10 is a perspective view of a packaging material production machine and a packaging material supply, according to exemplary embodiments of the disclosure.

FIG. 11 is a top view with respect to FIG. 10.

FIG. 12 is a perspective view of a packaging material production machine and a packaging material supply, according to exemplary embodiments of the disclosure, with four packaging material supply stacks.

FIG. 13 is a side view with respect to FIG. 12.

FIG. 14 is a top view with respect to FIGS. 12 and 13.

FIG. 15 is a perspective view of a section of a packaging material production machine according to an exemplary embodiment of the disclosure.

FIG. 16 is a top view with respect to FIG. 15.

FIG. 17 is a sectional view according to line XVII-XVII of FIG. 16.

FIG. 18 is a perspective rear view with respect to FIGS. 15-17.

FIG. 19 is a rear view with respect to FIGS. 15-18.

FIGS. 20-25 show different views of packaging material production machines and packaging material supplies according to exemplary embodiments of the present disclosure.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

An object of the present disclosure is to overcome the disadvantages of the prior art, which includes to provide a packaging material production machine in which safe insertion of the packaging material is ensured regardless of its position with respect to the packaging material production machine.

Accordingly, a packaging material production machine for manufacturing a packaging material product is provided. A packaging material product may, for example, have a tubular, spiral, and/or cushion pad-like shape.

The packaging material production machine according to the disclosure comprises a feed funnel for feeding packaging material from a web-shaped packaging material supply, which may be provided for example in the form of a leporello stack or in roll form, into the packaging material production machine. The packaging material web may be made of paper, such as recycled paper, in particular recycled paper and/or 100% recyclable paper, which may be manufactured without chemical ingredients. Recycled paper is particularly paper materials with a low percentage (less than 50%) of fresh fiber-containing paper material. For example, paper materials containing 70% to 100% recycled paper are used. The recycled paper in the sense of the present disclosure can be paper material that can have a tensile strength index along the machine direction of at most 90 Nm/g, preferably a tensile strength of 15 Nm/g to 60 Nm/g, and a tensile strength index across the machine direction of at most 60 Nm/g, preferably a tensile strength of 5 Nm/g to 40 Nm/g. A DIN EN ISO 1924-2 or DIN EN ISO 1924-3 standard can be used to determine the tensile strength or tensile strength index. In addition, or alternatively, a recycled paper property or recovered paper property can be characterized by the so-called bursting resistance. A material in this sense is recycled paper with a burst index of at most 3.0 kPa*m\hat{ }2/g, preferably with a burst index of 0.8 kPa*m\hat{ }2/g to 2.5 kPa*m\hat{ }2/g. The DIN EN ISO 2758 standard is used to determine the bursting index. Furthermore, the packaging material has a weight per unit area of, in particular, 40 g/m2 to max. 140 g/m2. According to the disclosure, the starting packaging material can be in the form of a material web roll or a zigzag-folded packaging material stack, also known as a leporello stack.

Downstream of the feed funnel in the conveying direction, the packaging material production machine can have packaging material processing equipment, such as a forming device, for example, for forming the flat packaging material web or the tubular packaging material strand into a three-dimensional packaging material product, an embossing/punching device for introducing embossments and/or perforations into the packaging material web, and/or a delivery/cutting device for cutting packaging material products of desired length from the web-shaped or tubular packaging material strand.

In accordance with a first aspect of the present disclosure, the packaging material production machine includes a deflection shaft mounted in a free-wheeling manner on the packaging material production machine for introducing or feeding the packaging material into the feed funnel. The deflection shaft may be arranged to deflect the web of packaging material coming from the packaging material supply along its conveying path. In particular, the deflection shaft changes a conveying direction of the packaging material web inside the packaging material production machine relative to a feeding direction outside the packaging material production machine from the packaging material supply to the packaging material production machine. The deflection shaft may be in an idle state. For example, the deflection shaft is not driven by a motor or similar drive component, but rotates solely as a result of frictional contact with the packaging material deflected by the deflection shaft. For example, a particularly low-friction bearing can be provided for the deflection shaft, for example by selecting a low-friction material pairing, by lubrication and/or by producing a lubricating film (full lubrication).

The deflection shaft has lateral end sections whose diameter increases continuously outward at least in sections. The term lateral is to be understood with reference to a width extension along an axis of rotation of the deflection shaft, about which the latter rotates during a rotational movement. It is possible for the lateral end sections to increase continuously in diameter up to a respective end-side outer surface of the deflection shaft. Furthermore, it is conceivable that the end-side lateral outer surfaces, in particular end faces, of the deflection shaft are directly connected by a cylinder section, which can be narrow and/or have a dimension in the direction of the axis of rotation of 5 mm to, for example, 20 mm. The cylinder sections are then connected by the lateral end sections with (viewed from the lateral outside) continuously decreasing diameter. The two lateral end sections are connected to each other via an elongated cylindrical shaft section, which may have dimensions in the range from 140 mm to 500 mm, for example. It can be provided that the width dimensioning of the cylindrical shaft section is selected to be at least as large as a width dimensioning of the web-shaped packaging material.

An advantage of the present disclosure is that the packaging material production machine no longer necessarily requires a holding device for the packaging material supply. In this respect, parts and space can be saved, resulting in a particularly compact packaging material production machine. Via the deflection shaft with the lateral end sections shaped according to the disclosure, a safe and reliable feeding of the packaging material into the packaging material production machine is ensured irrespective of the positioning of the packaging material supply. The lateral end sections can cause the packaging material to be fed to the packaging material supply centered with respect to a central axis of the feed funnel, regardless of the positioning of the packaging material supply. As a result, the likelihood of packaging material jams and thus downtime is reduced. For according to the present disclosure, it is achieved that even packaging material that is fed laterally and/or transversely to the packaging material production machine is introduced or guided into the feed funnel in the direction of the feed funnel center axis and/or as centrally as possible by means of the lateral end sections that increase in diameter towards the outside.

According to an exemplary embodiment of the present disclosure, the lateral end portions are at least in sections frustoconical in shape. Alternatively, the lateral end portions may have convexly or concavely curved peripheral surfaces, particularly unwinding surfaces for the packaging material. According to an exemplary further development, the frustoconical end sections have a cone angle, also called an opening angle, in the range from 2° to 178°, in particular in the range from 10° to 50°, 20° to 100° or in the range from 30° to 70°. For example, the cone angle is about 50°.

According to another exemplary embodiment of the packaging material production machine according to the disclosure, the deflection shaft has a length in the range from 150 mm to 1000 mm, in particular in the range from 200 mm to 800 mm or in the range from 300 mm to 600 mm. For example, the length of the deflection shaft is about 400 mm. Furthermore, it may be provided that the lateral end sections each have a length in the range of 5 mm to 250 mm, in particular in the range of 10 mm to 200 mm, 20 mm to 150 mm or in the range of 50 mm to 100 mm. For example, the length is approximately 70 mm. Alternatively or additionally, a cylinder section connecting the lateral end sections may have a length in the range from 140 mm to 500 mm, in particular in the range from 200 mm to 300 mm, in particular about 260 mm.

According to another exemplary embodiment of the packaging material production machine according to the disclosure, the deflection shaft is positioned upstream of the feed funnel and/or mounted on the feed funnel. For example, the feed funnel and the deflection shaft form a mounting unit that can be removably attached to the packaging material production machine. For example, the feed funnel has a feed opening through which the packaging material is fed to the feed funnel. The deflection shaft is positioned upstream of the feed opening in the feed direction, so that the incoming packaging material is first deflected via the deflection shaft and fed into the feed opening, in particular in a targeted and/or centered manner. A position of the deflection shaft with respect to a feed opening of the feed funnel can be adjustable. Furthermore, an orientation of the deflection shaft, in particular an orientation of the axis of rotation of the deflection shaft, can be adjustable with respect to the feed opening. Due to the adjustability or adjustability of the deflection shaft, it is possible to react flexibly to different packaging material supply positions and/or materials, in particular in order to always ensure the central supply of the packaging material into the feed funnel. According to an exemplary further development of the packaging material production machine according to the disclosure, the deflection shaft is mounted on the feed funnel in a height-adjustable manner. The height adjustability can be realized in such a way that the orientation of the axis of rotation of the deflection shaft remains constant in space and/or with respect to the feed opening, while its vertical position can be changed. It has been found that the height adjustability of the deflection shaft, in particular, can be used to react flexibly and reliably to different positions of the packaging material supply with respect to the packaging material machine.

In another exemplary embodiment of the packaging material production machine according to the disclosure, the latter comprises an adjusting device for attaching the deflection shaft to the feed funnel and for displacing or repositioning the deflection shaft stepwise or continuously relative to the feed funnel. The adjusting device can be configured in such a way that, on the one hand, it has fastening means for attaching the deflection shaft to the feed funnel and, on the other hand, it has an adjusting mechanism with which the position of the deflection shaft and/or the orientation of the deflection shaft rotation axis can be adjusted, in particular adjusted in height.

According to an exemplary further development of the present disclosure, the adjusting device is configured as a swivel mechanism. Furthermore, the adjusting mechanism may allow a pivoting movement of up to 180°, in particular of up to 160°, 145° or of up to 130°. The swivel mechanism can define a swivel axis about which the deflection shaft, in particular the deflection shaft rotation axis, can be swiveled. For example, the pivot axis is stationary or stationary with respect to the packaging material production machine during a pivotal movement of the deflection shaft. Furthermore, the adjusting device can be set up to swivel the deflection shaft between a lower end position, in which an axis of rotation of the deflection shaft is arranged below a swivel axis of the swivel mechanism, and an upper end position, in which the axis of rotation of the deflection shaft is arranged above the swivel axis of the swivel mechanism. In this way, it is possible to react particularly flexibly to different packaging material supply positions and furthermore to feed the packaging material reliably to the feed funnel via the deflection shaft, in particular centered. For example, the deflection shaft can perform a pendulum movement with respect to the swivel axis. In the side view, in the lower end position, the deflection shaft rotation axis can be on one side with respect to the feed direction with respect to the pivot axis, and in the upper end position, it can be on the other side of the pivot axis. In the lower end position, the axis of rotation can be located behind the swivel axis with respect to the conveying direction, and in the upper end position, it can be located in front of the swivel axis.

In a further exemplary further development of the packaging material production machine according to the disclosure, the adjustment device (adjuster) has a latching mechanism (latch) which defines at least two predefined latching positions for the deflection shaft, in particular for the lower and upper end positions of the deflection shaft. In the latching positions, the deflection shaft is detachably fixed and/or secured against pivoting. The latching mechanism can be configured in such a way that when the deflection shaft assumes at least two predefined latching positions, the at least two latching positions are automatically assumed in order to fix the positions of the deflection shaft. According to an exemplary further development, the latching mechanism defines a plurality of latching positions in which the deflection shaft can be releasably fixed and secured against further pivoting movement. The at least two, in particular the plurality, of latching positions can be distributed along an arc line, in particular an arc line curved in the shape of a circular arc, which is traversed by the deflection shaft rotational axis during the pivoting movement. For example, the latching positions are evenly distributed along the arc line. According to an exemplary further development, the latching mechanism defines at least three latching positions distributed in particular uniformly in accordance with the pivoting movement, in particular along the arcuate curved line.

According to another exemplary embodiment of the packaging material production machine according to the disclosure, the adjusting device defines at least two locking positions for the deflection shaft, in particular for the lower and upper end position of the deflection shaft, in which the deflection shaft can be fixed in a detachable frictionally engaged manner and/or can be secured against further pivoting movement. For example, the adjusting device enables continuous displacement and locking of the deflection shaft. A static frictional force must be overcome in order to leave the locking positions. For example, the static friction force may be between a deflection shaft side part and a feed funnel side part. The adjusting device can be configured in such a way that a force is required to adjust the deflection shaft and no force is required to assume the locking positions, in particular the deflection shaft automatically assumes the locking positions and/or the static frictional force is automatically built up again.

In another exemplary embodiment of the packaging material production machine according to the disclosure, the latching mechanism (latch) comprises at least two latching elements on the feed funnel side, such as latching projections or latching recesses, and at least one latching part on the deflection shaft side, such as a latching recess or a latching projection. To fix the deflection shaft in a latching position, the latching part can enter into releasable engagement with a respective one of the latching elements. The latching elements may be formed in a wall of the feed funnel or on a separate component, such as the adjusting device, which is, however, firmly connected to the feed funnel during a pivoting movement of the deflection shaft. For example, the latching part is formed on the adjusting device. For example, a hole part may be fixedly connected to the feed funnel, the holes realizing the latching elements on the feed funnel side. Further, a connecting part may be non-rotatably connected to the deflection shaft, on the one hand, and immovably connected to the hole part, on the other hand, and have the deflection shaft-side latching part, so that when the deflection shaft is pivoted, the latching part formed on the connecting part, which is an elongated thin plate, for example, is pivoted relative to the feed funnel-side hole part. The holes in the perforated part realizing the latching elements define the latching positions and are arranged along an arc line, in particular an arc line of a circle, with respect to the pivot axis, in particular uniformly distributed in the perforated plate. During a pivoting movement of the deflection shaft, the latching part on the deflection shaft side, which can be, for example, a bolt, in particular a spring-preloaded bolt, passes over the latching elements in order to be able to engage with the respective latching element, if necessary, in order to fix the deflection shaft. In the event that the latching element is pretensioned, in particular spring-pretensioned, the latching element can independently engage with the latching elements on the feed funnel. In order to drive over a latching element without latching, an operator can, for example, hold back the latching part on the deflection shaft side and only release it again in the desired latching position so that latching takes place.

According to an exemplary further development of the packaging material production machine according to the disclosure, the feed funnel has a feed opening. The feed opening has an opening height oriented transversely to the feed direction of the packaging material, in particular measured in the vertical direction, of at least 1 mm, in particular of at least 5 mm, 10 mm or at least 15 mm, and of at most 120 mm, in particular of at most 20 mm or of about 19 mm. The narrow feed opening prevents any injury to operating personnel, in particular any reaching into the interior of the feed funnel and/or the packaging material production machine, for example by with a hand, a finger or the like.

In an exemplary further development of the packaging material production machine according to the disclosure, the feed funnel has a feed opening. The feed opening can be delimited by two feed rods, in particular cylindrical feed rods, which are arranged at a distance from one another, in particular vertically, and are mounted so as to rotate freely on the feed funnel. For example, the swivel axis of the swiveling device is located in the area of the lower feed rod. In particular, the swivel axis is oriented coaxially to the lower feed rod.

According to another aspect of the present disclosure, which may be combined with the foregoing aspects and exemplary embodiments, there is provided a packaging material production machine for manufacturing a packaging material product. For example, a packaging material product may have a tubular, spiral, and/or cushion pad-like shape.

The packaging material production machine according to the disclosure comprises a feed funnel for feeding packaging material from a web-shaped packaging material supply, which may be provided for example in the form of a leporello stack or in roll form, into the packaging material production machine. The packaging material web may be made of paper, such as recycled paper, in particular recycled paper and/or 100% recyclable paper, which may be manufactured without chemical ingredients. Recycled paper is particularly paper materials with a low percentage (less than 50%) of fresh fiber-containing paper material. For example, paper materials containing 70% to 100% recycled paper are used. The recycled paper in the sense of the present disclosure can be paper material that can have a tensile strength index along the machine direction of at most 90 Nm/g, preferably a tensile strength of 15 Nm/g to 60 Nm/g, and a tensile strength index across the machine direction of at most 60 Nm/g, preferably a tensile strength of 5 Nm/g to 40 Nm/g. A DIN EN ISO 1924-2 or DIN EN ISO 1924-3 standard can be used to determine the tensile strength or tensile strength index. In addition, or alternatively, a recycled paper property or recovered paper property can be characterized by the so-called bursting resistance. A material in this sense is recycled paper with a burst index of at most 3.0 kPa*m\hat{ }2/g, preferably with a burst index of 0.8 kPa*m\hat{ }2/g to 2.5 kPa*m\hat{ }2/g. The DIN EN ISO 2758 standard is used to determine the bursting index. Furthermore, the packaging material has a mass per unit area of, in particular, 40 g/m2 to max. 140 g/m2 . According to the disclosure, the starting packaging material can be in the form of a material web roll or a zigzag-folded packaging material stack, also known as a leporello stack.

According to another aspect of the present disclosure, the packaging material production machine comprises a stationary and/or stationary deflection bar for introducing or feeding the packaging material into the feed funnel. The deflection rod has a substantially constant cross-section, particularly along its full longitudinal extent. Further, the deflection rod is curved away from the feed funnel along its longitudinal extent. The feed funnel may define a conveying plane in which the planar web-shaped packaging material is conveyed within the feed funnel. In other words, the web-like planar packaging material lies within the conveying plane. The curvature of the deflection rod may be formed in the conveying plane. According to the disclosure, it has been found that via curvature of the deflection rod, analogous to the deflection shaft with the lateral end portions increasing in diameter according to the first aspect of the present disclosure, a centering effect of the incoming packaging material into the feed funnel is accompanied. In particular, this ensures that regardless of the positioning of the packaging material supply with respect to the packaging material production machine, the packaging material is introduced into the feed funnel in a reliable and, in particular, centered manner. Thus, packaging delays and/or packaging jams can be avoided. The packaging material web from packaging material supplies offset laterally with respect to the packaging material production machine is always guided to its center and/or a center of the feed funnel via the curved deflection rod shape. Furthermore, the cross-section of the deflection rod can be at least semi-cylindrical, in particular fully cylindrical, or oval. The deflection rod may further be configured such that a deflection circumferential surface of the deflection rod facing away from the feed funnel is curved in cross-section.

Downstream of the feed funnel in the conveying direction, the packaging material production machine can have packaging material processing equipment, such as a forming device, for example, for forming the flat packaging material web or the tubular packaging material strand into a three-dimensional packaging material product, an embossing/punching device for introducing embossments and/or perforations into the packaging material web, and/or a delivery/cutting device for cutting packaging material products of desired length from the web-shaped or tubular packaging material strand.

The deflector rod can be set up to deflect the packaging material web coming from the packaging material supply along its conveying path. In particular, the deflector rod changes a conveying direction of the packaging material web inside the packaging material production machine relative to a feed direction outside the packaging material production machine from the packaging material supply to the packaging material production machine.

According to an exemplary further development of the present disclosure, the deflection rod has a circular arc shape. Furthermore, a center of curvature of the deflection rod may be located downstream of the feed funnel. By having the center of curvature downstream of the feed funnel, it can be ensured that the curvature of the deflection rod is not too strong, so that the centering effect according to the disclosure can no longer be achieved.

According to an exemplary further development, a curvature angle of the deflection rod is in the range of 20° to 175°, in particular in the range of 30° to 150°, 40° to 125° or in the range of 50° to 100°. With the curvature ratio ranges according to the disclosure, an optimum of centering effect when introducing the web-shaped packaging material, manufacturability and compactness of the packaging material production machine has been identified.

According to a further exemplary further development of the packaging material production machine according to the disclosure, a pair of in particular identically shaped and/or identically oriented deflector rods delimits a feed opening of the feed funnel. The feed opening can have an opening height oriented transversely to the feed direction of the packaging material, in particular in the vertical direction, of at least 1 mm, in particular of at least 5 mm, 10 mm or at least 15 mm, and of at most 120 mm, in particular of at most 20 mm or of about 19 mm. In this way, unintentional intervention in the feed funnel interior and/or a downstream packaging material processing device by an operator, for example with a finger or a hand, is precluded.

According to another exemplary embodiment relating to all aspects of the present disclosure, there is provided a packaging material production machine in which the feed funnel forms a chute. The chute may have a rectangular or curved, particularly round or oval, cross-section. Furthermore, the chute may continuously taper from a feed opening towards a discharge opening at least in sections. Furthermore, the chute may have circumferential chute walls which are open or recessed substantially exclusively in the region of the feed opening and/or the discharge opening. The chute walls are adapted to guide or direct the packaging material to the discharge opening. In this context, it may be provided that the chute walls are manufactured from one piece, for example bent or otherwise formed from a sheet metal part, and/or are manufactured by bending. It should be understood that alternative methods of manufacturing the chute or chute walls are conceivable without departing from the basic idea of the present disclosure.

In another exemplary embodiment of the present packaging material production machine according to the disclosure, the packaging material production machine comprises a packaging material processing device, such as a forming and/or embossing and/or separating device, which is connected to the feed funnel. The feed funnel and the deflection rod, in particular the pair of deflection rods, may be detachably attachable or fastened to the packaging material processing device, for example, as a mounting unit. The fastening can, for example, take place in a form-locking and/or force-locking manner.

According to a further aspect of the present disclosure, which may be combined with the preceding aspects and exemplary embodiments, there is provided a deflection device for introducing or feeding packaging material from a web-shaped packaging material supply, provided for example in the form of a leporello stack or in roll form, into a packaging material production machine, in particular configured according to one or more exemplary embodiments. A packaging material product may, for example, have a tubular, spiral, and/or cushion pad-like shape. In particular, the deflection device serves to introduce, feed and/or deflect a packaging material web coming from a packaging material supply into a packaging material machine in such a way as to ensure a preferably centered/or reliable introduction into the packaging material production machine. The packaging material web may be made of paper, such as recycled paper, in particular recycled paper and/or 100% recyclable paper, which may be made without chemical ingredients. Recycled paper is in particular paper materials with a low content (less than 50%) of fresh fiber containing paper material. For example, paper materials containing 70% to 100% recycled paper are used. The recycled paper in the sense of the present disclosure can be paper material that can have a tensile strength index along the machine direction of at most 90 Nm/g, preferably a tensile strength of 15 Nm/g to 60 Nm/g, and a tensile strength index across the machine direction of at most 60 Nm/g, preferably a tensile strength of 5 Nm/g to 40 Nm/g. A DIN EN ISO 1924-2 or DIN EN ISO 1924-3 standard can be used to determine the tensile strength or tensile strength index. In addition, or alternatively, a recycled paper property or recovered paper property can be characterized by the so-called bursting resistance. A material in this sense is recycled paper with a burst index of at most 3.0 kPa*m\hat{ }2/g, preferably with a burst index of 0.8 kPa*m\hat{ }2/g to 2.5 kPa*m\hat{ }2/g. The DIN EN ISO 2758 standard is used to determine the bursting index. Furthermore, the packaging material has a mass per unit area of, in particular, 40 g/m2 to max. 140 g/m2 . According to the disclosure, the starting packaging material can be in the form of a material web roll or a zigzag-folded packaging material stack, also known as a leporello stack.

The deflection device comprises a deflection shaft which is mounted in a free-wheeling manner, with lateral end sections whose diameters increase continuously outwards at least in sections. The deflection shaft can be configured according to one of the previously described aspects or exemplary embodiments. Alternatively, the deflection device can have a stationary or stationary deflection rod which has a substantially constant cross section and is curved along its longitudinal extent, in particular in the shape of an arc of a circle. The deflection rod can be configured according to one of the previously described aspects or exemplary embodiments.

The deflection device may be adapted to be attached to a packaging material production machine. For example, the deflection device comprises fastening means for detachably attaching the deflection rod to the packaging material production machine. This makes it possible to equip or upgrade existing packaging material production machines with a deflection device according to the disclosure. The deflection device can also be configured in such a way that it can be arranged upstream of a feed opening of the packaging material production machine.

According to a further aspect of the present disclosure, which may be combined with the preceding aspects and exemplary embodiments, a system comprising a packaging material production machine, in particular configured according to one of the preceding embodiments or aspects, for manufacturing a packaging material product and a packaging material supply of a web-shaped packaging material, for example in the form of a leporello stack or in roll form for insertion into the packaging material production machine. According to the further aspect, the packaging material supply is arranged with respect to the packaging material production machine such that a feed direction of the packaging material web towards the packaging material production machine outside the packaging material production machine is inclined with respect to a feed direction of the packaging material web inside the packaging material production machine. For example, the inclination is substantially constant from leaving the packaging material supply to entering the packaging material production machine, such as a feed funnel of the packaging material production machine. For example, the inclination may be understood with respect to a planar projection of the system, for example according to a top view of the system. For example, the inclination is achieved by the packaging material supply being offset with respect to the packaging material production machine, in particular with respect to an entry into the packaging material production machine. For example, an inlet opening into the packaging material production machine, in particular into a feed funnel of the packaging material production machine, defines a width direction with respect to which the feed direction of the packaging material is inclined, for example, at an angle of 0° to 85°. In particular, the feed direction of the packaging material web outside the packaging material production machine is inclined with respect to a feed direction of the packaging material inside the packaging material production machine at an angle of at least 10°, in particular at least 20° or at least 30°, and in particular of at most 85°, 80° or of at most 75°. For example, the system comprises at least two packaging material supplies placed at different positions, which can be fed successively or simultaneously to the packaging material production machine.

In the following description of exemplary embodiments of the present disclosure, a packaging material production machine according to the disclosure is generally designated by reference numeral 1. In the exemplary embodiments of the disclosure shown, the packaging material is paper provided in accordance with some embodiments in the form of a leporello stack and in other embodiments in roll form. The present disclosure is not limited in the form of packaging material.

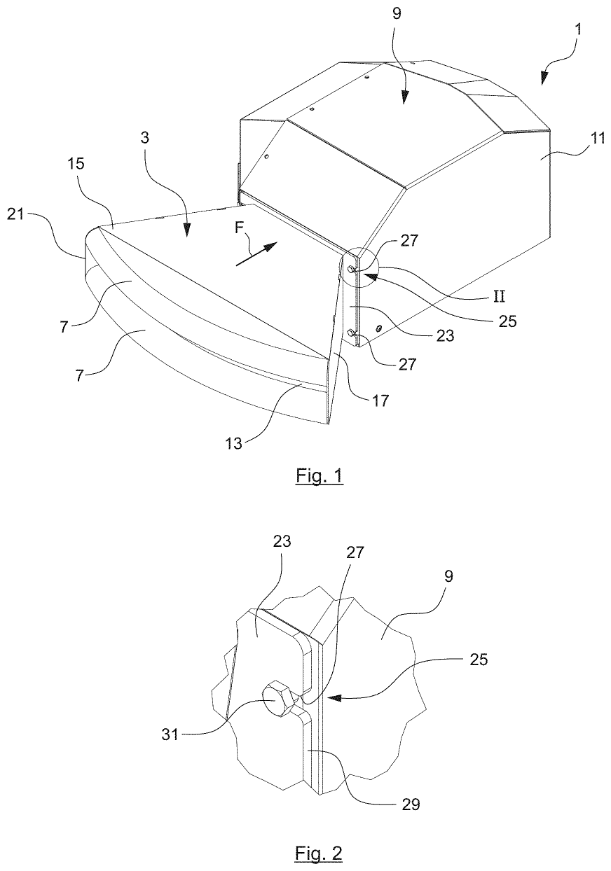

In FIG. 1, a packaging material production machine according to the disclosure is shown in accordance with an exemplary embodiment in a perspective view from above. The packaging material production machine 1 essentially comprises the following main components: a feed funnel 3 for introducing packaging material from a web-shaped packaging material supply not shown, which is formed, for example, in FIG. 6 as a leporello stack and is provided with the reference numeral 5; a deflection device (deflector) configured as a deflecting shaft 7 for introducing the packaging material into the feed funnel 3; and a packaging material processing device 9, such as a forming device, an embossing/punching device and/or an dispensing/cutting device, downstream of the feed funnel 3.

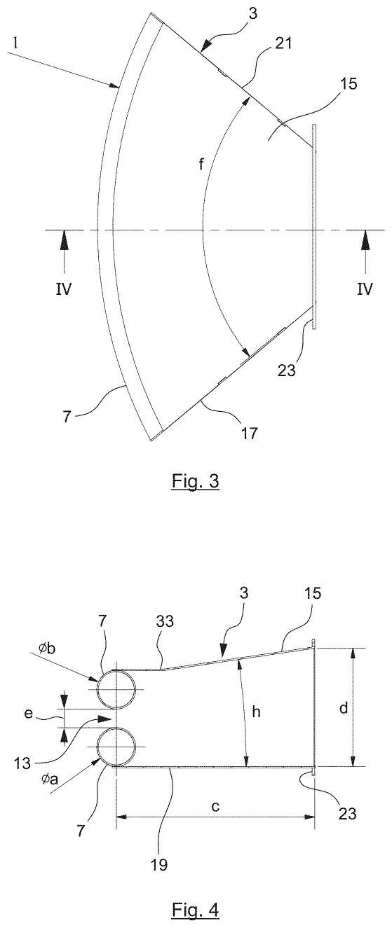

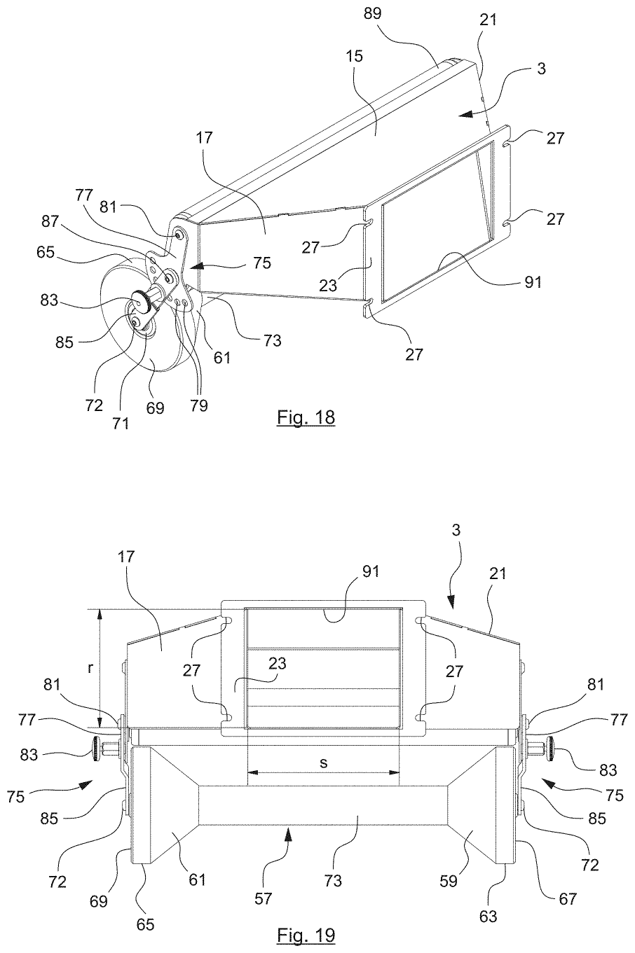

Of the packaging material processing device 9, essentially only its housing 11 can be seen, which is designed to be essentially completely closed except for an insertion opening, not shown, for inserting the packaging material from the feed funnel 3 into the packaging material processing device 9 and an output opening opposite the insertion opening, which can be adapted in shape to an outer diameter of the packaging material product to be produced. Referring to FIG. 1, the feed funnel 3 has a rectangular inner and outer cross-section which tapers continuously from a feed opening 13 in the region of the deflection rod 7 to a discharge opening 91 shown in FIGS. 18 and 19 facing the packaging material processing device 9. The feed funnel 3 forms a chute in the interior for guiding the packaging material and has circumferential chute walls 15, 17, 19, 21. The feed opening 13 of the feed funnel 3 is bounded by the deflection rod 7 and a further deflection rod 7 of identical configuration vertically above the deflection rod 7, so that a narrow gap is formed over the entire width extension of the deflection rod 7, which forms the feed opening 13. The deflection rods 7 are stationary or immovably attached to the feed funnel and have a round shape in cross-section (see FIG. 4). The deflection rods 7 are curved away from the feed funnel 3 along their longitudinal extension and each form a circular arc shape. As shown in

FIG. 1, the deflection rods 7 are fixedly attached to respective inner sides of the chute walls 17, 21. A conveying direction F of the web-shaped packaging material within the packaging material production machine 1 is indicated by the arrow with the reference sign F.

Downstream of the conveying direction, the feed funnel 3 includes a mounting plate 23 which may be made in one piece with the chute walls and/or attached to the chute walls. The mounting plate 23 is flat and serves to be connected to a flat end face of the packaging material processing device 9, in which the feed opening for transferring the packaging material from the feed funnel 3 to the packaging material processing device 9 is provided. For the connection, an attachment configured as a form-fitting device 25 is provided, which is shown in detail in FIG. 2, which is a detailed view II from FIG. 1.

It is thus possible to detachably attach feed funnel 3 and deflector rod(s) 7 as a mounting unit to and from the packaging material processing device 9. As can be seen in detail in FIG. 2, the positive locking device 25 is realized in that the mounting plate 23 has lateral locking grooves 27. The latching grooves 27 are produced as rectilinear recesses which, starting from an abutting edge 29 of the mounting plate 23, are made inwardly in the solid material of the mounting plate 23. Two latching grooves 27 can be provided per lateral side. The latching grooves 27 cooperate with an engagement element 31, such as a bolt, on the packaging material processing device side, which projects from an end face, to which the mounting plate 23 is to be attached, of the packaging material processing device 9.

FIG. 3 shows a top view of the feed funnel 3 including the deflection rod 7 according to FIG. 1. FIG. 3 shows in particular the exemplary dimensioning of the feed funnel 3 and the deflection rod 7. The deflection rod 7, which is essentially curved in a plane in which the conveying direction F also lies and which is oriented essentially parallel to that plane in which the web-shaped packaging material is guided within the feed funnel 3, has a radius of curvature 1 of about 500 mm. Thereby, a center of curvature of the circular arc-shaped deflection rod 7 is located downstream of the feed funnel 3 or downstream of the mounting plate 23, respectively. The two opposite side walls 21, 17 of the chute of the feed funnel 3 form a funnel angle f of about 80° to each other. The mounting plate 23 is oriented essentially perpendicular to the feed direction F.

FIG. 4 shows a sectional view based on line IV-IV from FIG. 3. The feed funnel 3 has a length c of 30 mm to 900 mm, for example of about 200 mm, considered in conveying direction F. Following the deflection rods 7, the chute walls, in particular the bottom wall 19 and the top wall 15, extend essentially flat and parallel to one another up to a bending point 33 in the top chute wall 15, from which the top funnel wall 15 can be inclined at an angle between 0° and 75°, for example of about 8°, with respect to the lower bottom chute wall 19, so that in the conveying direction F a vertical height dimensioned transversely to the conveying direction F increases continuously up to a maximum vertical height d in the region of the mounting plate 23. The vertical height d can be in the range from 20 mm to 300 mm, for example at about 120 mm. The gap formed between the deflection rods 7, which are in particular of the same shape and are arranged in alignment one above the other, and which defines the feed opening 13, can have a vertical height e, dimensioned transversely to the conveying direction F, of from 1 mm to 20 mm, for example of about 19 mm. The deflection rods 7, which are constant in cross-section, have a diameter in the range from 5 mm to 200 mm, for example about 40 mm, and the deflection rods 7 can be hollow and thin-walled.

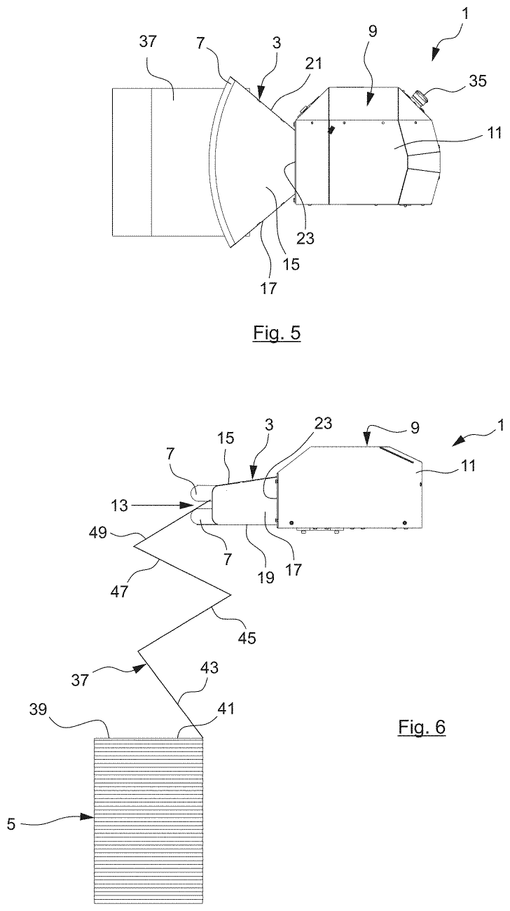

In the top view according to FIG. 5 of the packaging material production machine 1 according to FIG. 1, a rear actuating switch 35, i.e. arranged downstream of the conveying direction, is arranged on the housing 11 of the packaging material finishing device 9 in such a way that the switch 35 protrudes from the housing 11. The switch 35 may serve, for example, to control the operation of the packaging material processing machine 1, in particular to start and stop it. Within the housing 11, for example, an electric motor may be accommodated which, as a consequence of an actuation of the switch 35, causes a conveying of the packaging material web, which is schematically shown in FIG. 5 and is provided with the reference sign 37, into the packaging material production machine 1.

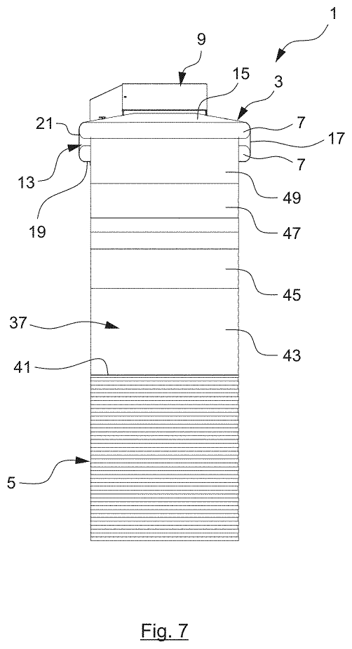

In FIGS. 6 and 7, the packaging material production machine 1 is loaded with packaging material 37 from a packaging material supply stack 5. The packaging material 37, which is zigzag-folded or stacked in leporello form, thus forms the packaging material supply stack 5 and fans out as it is fed into the packaging material production machine 1, as shown schematically in FIGS. 6 and 7. Starting from a supply stack top 39, which increasingly moves vertically downward and is formed by a subsequent packaging material folding sheet 41 in each case as the packaging material 37 is increasingly conveyed away, the packaging material web 39 is drawn off. The packaging material folding sheets 43, 45, 47 and 49, which have already been fanned out, are drawn into the interior of the packaging material production machine 1 through the feed opening 13 and introduced and deflected by means of the deflecting device 10, in particular the deflecting rod 7. The packaging material folding sheets already arranged or drawn in inside the packaging material production machine 1 are not shown.

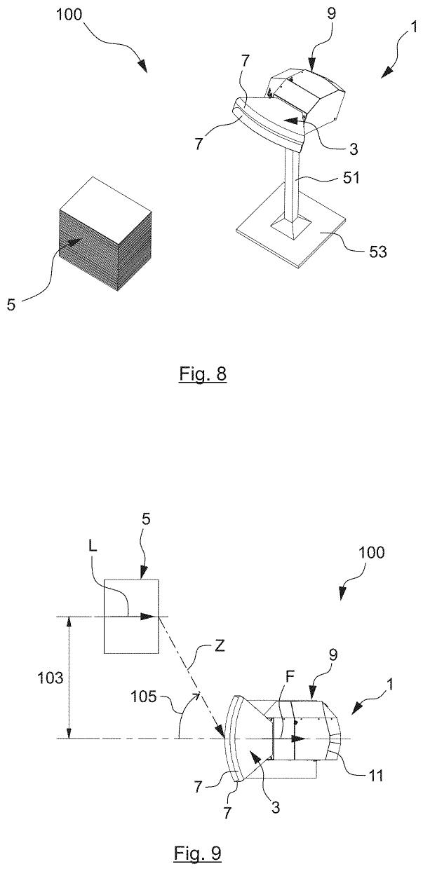

FIGS. 8 and 9 show an exemplary arrangement 100 of a packaging material production machine 1 according to the disclosure, as well as a packaging material supply stack 5 which is fed to the packaging material production machine 1 for the production of packaging material products by means of the packaging material production machine 1. In particular, it can be seen in FIG. 8 that the packaging material production machine 1 does not require a separate receiving device or the like for the packaging material supply stack 5.

The packaging material production machine 1 shown in FIG. 8 includes a stand 51 and a floor support 53, so that the packaging material production machine 1 can be easily operated by a standing operator. Furthermore, it can be seen from a synopsis of FIGS. 8 and 9 that the packaging material supply stack 5 can be oriented as desired with respect to the packaging material production machine 1 and a conveying direction F defined by the packaging material production machine 1 (cf. FIG. 9). Furthermore, as it is shown in FIG. 8, the packaging material processing device 9 and the feed funnel 3, which can be seen as a unit due to the attachment of the feed funnel 3 to the packaging material processing device 9 and can be inclined with respect to the upright 51, can be inclined. Accordingly, the conveying direction F defined thereby is inclined downward in the vertical direction starting from the feed funnel 7 in the direction of the packaging material processing device 9.

Furthermore, it can be seen in particular from FIG. 9 that the packaging material supply stack 5 is arranged with respect to the packaging material production machine 1 in such a way that in the planar projection a feed direction Z, which is indicated in FIG. 9 by a dash-dotted arrow line, is inclined from the packaging material supply stack 5 towards the packaging material production machine 1 outside the packaging material production machine 1 with respect to the feed direction F defined by the packaging material production machine 1. The angle in this case is approximately 60°. For example, angles of up to 85° are conceivable. By means of the circular arc shape of the deflection rods 7, which can also be seen in the planar projection and which curve away from the feed funnel 3, it is nevertheless ensured that the packaging material 37 enters the feed funnel 3 reliably and, in particular, in a centered manner, without any packaging delays or even a packaging jam occurring.

In FIGS. 8 and 9, the packaging material supply stack 5 is laterally offset with respect to the packaging material production machine 1, which is schematically represented by the distance 103 in FIG. 9. In this respect, there is a horizontal distance 103 with respect to the conveying direction F within the packaging material production machine 1 and the longitudinal web direction L of the stacked packaging material 37 on the packaging material supply stack 5. The packaging material stack 105 is further arranged such that the longitudinal web direction L on the packaging material supply stack 5 is oriented parallel to the conveying direction F.

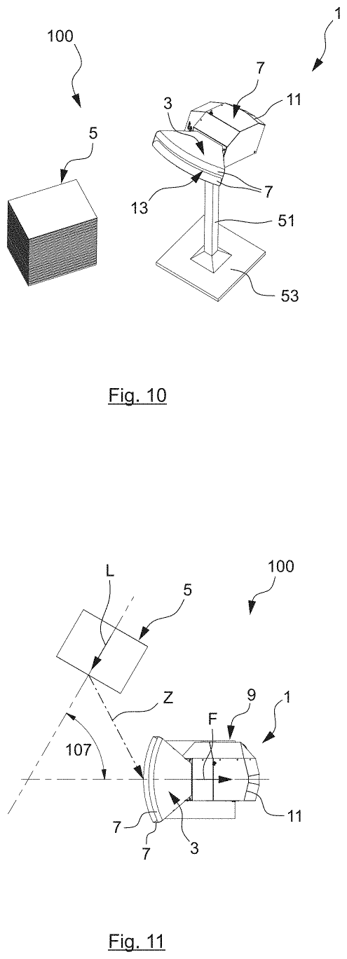

FIGS. 10-11 illustrate another exemplary arrangement 100 of a packaging material production machine 1 according to the disclosure and a packaging material supply stack 5 in leporello form. The packaging material production machine 1 is substantially identical in design to the packaging material production machine 1 of FIG. 8. The same applies to the packaging material supply stack 5. In contrast to the arrangement 100 of FIGS. 8 and 9, the packaging material supply stack 5 in the arrangement 100 of FIGS. 10 and 11 is arranged with respect to the packaging material production machine 1 in such a way that, on the one hand, the longitudinal web direction L defined on the packaging material supply stack 5 and, on the other hand, the feed direction Z of the packaging material 37 to the packaging material production machine 1 are inclined with respect to the feed direction F within the packaging material production machine 1.

In FIG. 11, the longitudinal web direction L on the packaging material supply stack 5 forms an angle 107 with respect to the conveying direction F inside the packaging material production machine 1. Furthermore, it can be seen that the feed direction Z outside the packaging material production machine is also inclined with respect to the feed direction F inside the packaging material production machine 1.

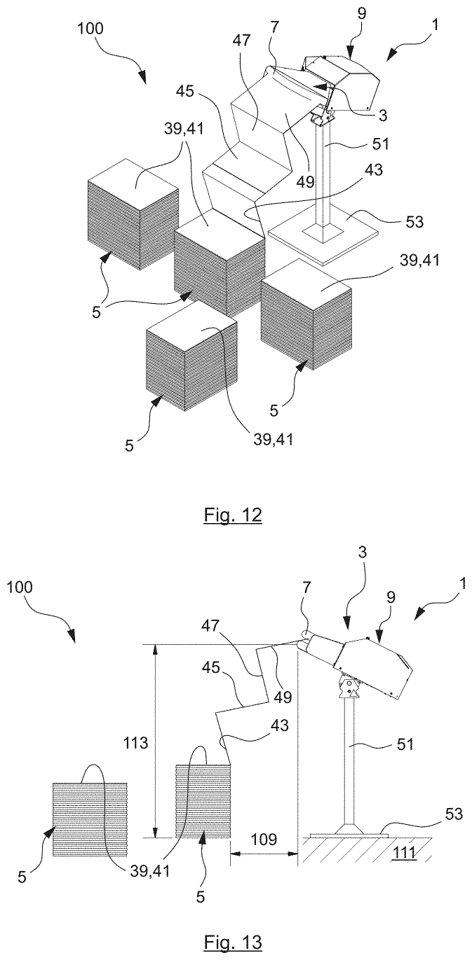

Referring to FIGS. 12-14, another exemplary arrangement 100 is shown comprising a packaging material production machine 1 configured substantially identically to the previous embodiments, and a packaging material supply of four packaging material supply stack 5 arranged in two rows of three packaging material supply stack 5 and one packaging material supply stack 5. The packaging material supply patches 5 are all provided in a zigzag fold or leporello form and are set up at different positions with respect to the packaging material production machine 1.

The arrangement 100 according to FIGS. 12 to 14 illustrates a further advantage of the present disclosure. Due to the fact that no separate receiving device is required for the packaging material supply stacks 5, since the packaging material supply stacks 5 can be flexibly positioned and set up with respect to the packaging material production machine 1 and, at the same time, a reliable and centered introduction of the packaging material web 37 into the packaging material web production machine 1 is ensured, a large supply of packaging material 37 or packaging material supply stacks 5 can be provided in the area of the packaging material production machine 1. For example, the packaging material supply stacks 5 can be fed sequentially to the packaging material production machine 1. A reloading time for changing to a further packaging material supply stack 5 is significantly shorter than is the case in the prior art, in which a predetermined position and/or receiving device for the packaging material supply stacks 5 was given, since while a change is being made from a used packaging material supply stack 5 to a new packaging material supply stack 5, a further packaging material supply stack 5, which is already in stock, can already be fed to the packaging material production machine 1.

In the schematic side view according to FIG. 13, it can be seen that the packaging material supply stacks 5 are displaced at least by the axial distance 109, which can lie, for example, in the range from −1000 mm to +1500 mm, the zero point being understood to be in the region of the feed opening 13 of the packaging material production machine 1. A vertical height from a base, which is indicated schematically by the hatching 111, to the lower deflection rod 7 of the packaging material production machine 1, which is provided with the reference sign 113, can, for example, be in the range from −5000 mm to +5000 mm, the zero point being understood to be at the vertical height of the deflection rod 7.

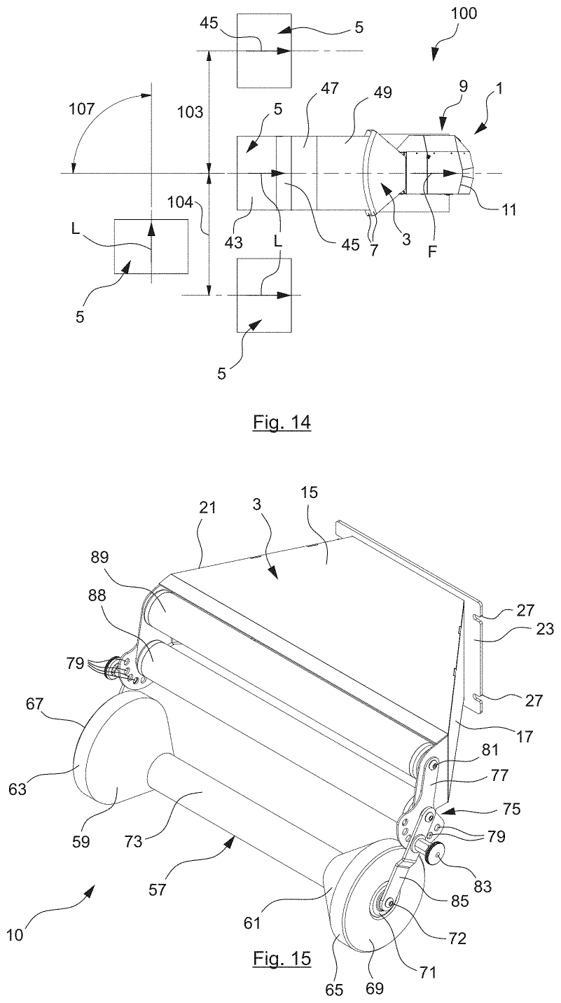

FIG. 14 shows the arrangement 100 of FIGS. 12 and 13 in planar projection, i.e. in a top view. The longitudinal web direction L of that packaging material stack 5 which is already being conveyed away by the packaging material production machine 1 is oriented approximately coaxially with the conveying direction F within the packaging material production machine. The two adjacent packaging material supply stacks 5 are laterally offset, resulting in a horizontal distance in planar projection 103 or 104. In addition to being horizontally offset, the rear packaging material supply stack 5 is inclined such that there is an angle 107 of approximately 90° between the longitudinal web direction L on the packaging material supply stack 5 and the conveying direction F within the packaging material production machine 1 in the planar projection. As a result, the feed direction Z of the corresponding packaging material supply stack 5 is also inclined with respect to the feed direction F within the packaging material production machine 1.

With reference to FIGS. 15-25, a further exemplary embodiment of a packaging material production machine 1 according to the disclosure is shown. In order to avoid repetition, the differences arising with respect to the preceding embodiments will be dealt with superficially in the following. Identical or similar components are provided with identical or similar reference signs.

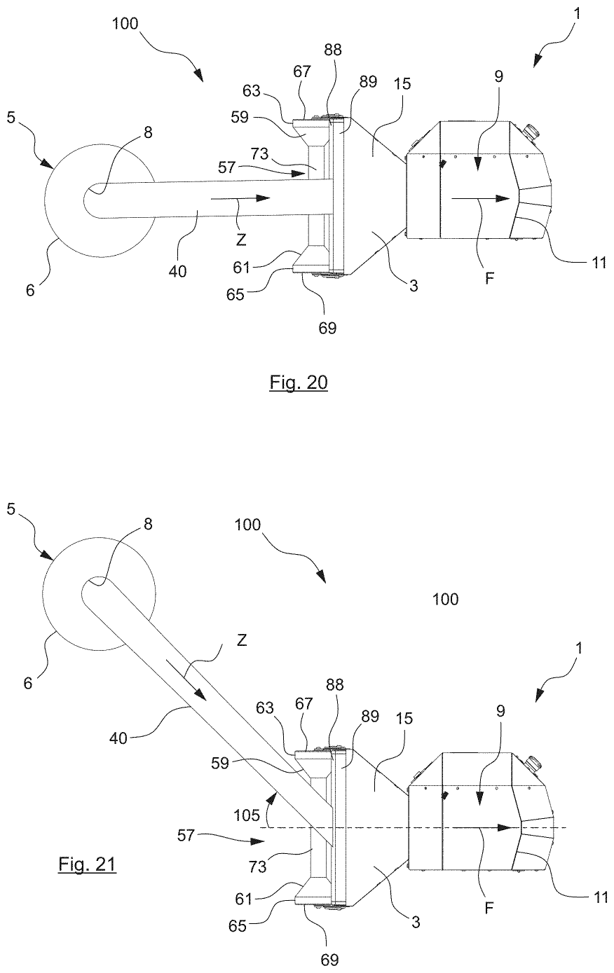

The packaging material production machine 1 according to FIG. 15 differs essentially in the deflecting device 10 for introducing and feeding the packaging material 37 into the feed funnel 3, which is formed substantially the same as in FIGS. 1-14. Instead of the stationary, circular arc-shaped deflection rod 7, or pair of deflection rods 7, there is provided a free-wheeling deflection shaft 57 mounted on the feed funnel 3, which is height-adjustably mounted on the feed funnel 3 and is also configured to ensure reliable and, in particular, centered feeding of packaging material 37 into the feed funnel 3 irrespective of the position of the packaging material supply stack 5 or a packaging material supply roll 6 (see FIG. 20). The deflection shaft 57 has lateral end portions 59, 61 on both lateral sides, the outer diameters of which continuously increase outwardly at least in sections. In FIGS. 15-25, the lateral end sections 59, 61 have a frustoconical shape. On the outside, the lateral end sections 59, 61 are adjoined by narrow cylindrical end sections 63, 65, which have flat end faces 67, 69, in each of which a central opening 71 is provided for the mounted in a free-wheeling manner of the deflection shaft 57. Between the two frustoconical end sections 59, 61, a rectilinearly extending shaft section 73 is formed, on which the packaging material 37 mainly rolls during a feed.

The lateral, frustoconical end sections 59, 61 essentially serve to feed the packaging material web 37, which comes from packaging material supply stacks 5 or packaging material supply rolls 6 that are offset with respect to the packaging material production machine 1 and in particular the conveying direction F within the packaging material production machine 1, reliably and in a centered manner into the feed funnel 3. The entire deflection shaft 57 is mounted so as to rotate freely and is rotatable about a center/rotation axis R, which is indicated in FIG. 17.

An adjustment device 75 is used to attach the deflection shaft 57 to the feed funnel 3, and to move the deflection shaft 57 relative to the feed funnel 3 in a stepwise and/or continuous manner. The adjustment device 75 includes a pivot mechanism that allows a pivotal movement of up to 180° for the deflection shaft 57. The swivel mechanism is constructed as follows: An elongated bulbous perforated plate 77, which is fixedly connected to the feed funnel 3 and widens towards the vertical bottom, defines predefined latching positions, which are realized by latching recesses 79 formed in the plate 77. The plate 77 is attached to the outside of the feed funnel 3 by means of a bolt 81. A latching projection 83, for example a spring-biased bolt fastened on the deflection shaft side, can latch into the latching recesses 79 when the corresponding latching recesses 79 are passed over in order to secure the deflection shaft 79 and prevent further pivoting of the deflection shaft 57. The latching projection 83 is arranged on an elongated connecting part 85 connected to the deflection shaft 57, which is fastened to the perforated plate 75 by means of a bearing pin 87 in order to define a stationary or packaging material production machine swivel axis S, which can be seen schematically in FIG. 17. About the swivel axis S, the deflection shaft 57 together with the connecting part 85 performs a swiveling or pendulum movement, wherein a swiveling movement can be up to 180°. The connecting part 85 is fastened to the deflection shaft 57 by means of a bearing bolt 72 (on each side of the deflection shaft 57). As mentioned above, the detent recesses 79 define detent positions when they engage with the detent projection 83 of the deflection shaft 57. Similar to the preceding embodiments according to FIGS. 1-14, a feed opening 13 into the funnel 3 is defined by two insertion rods 88, 89 arranged at a vertical distance e from each other, which are mounted on the feed funnel 3 in a freely rotating manner according to the exemplary embodiment of FIGS. 15-25. In cross-section, the insertion rods 88, 89 are round in shape and can have a diameter a, b, of about 5 mm to 2,000 mm, in particular of about 40 mm.

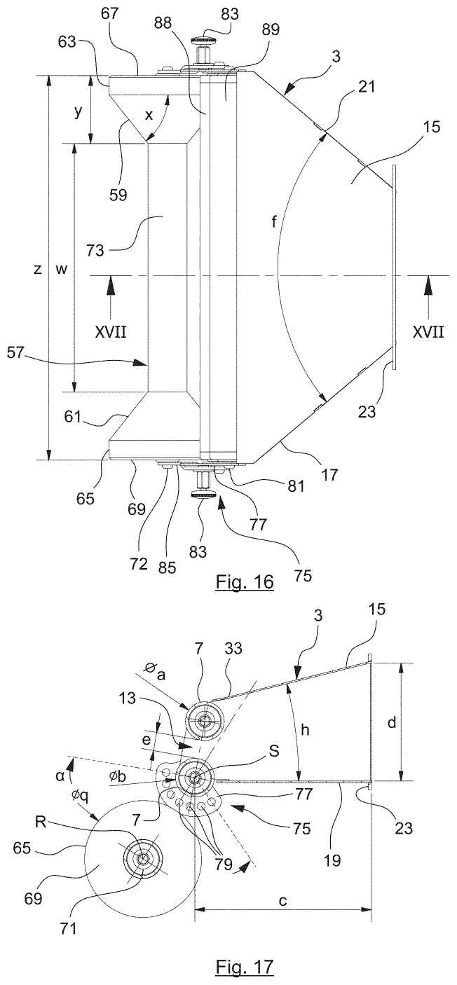

FIG. 16 shows the dimensions of the deflection shaft 57. A total longitudinal extension transverse to the conveying direction F of the deflection shaft 57 is approximately z=400 mm. The lateral end sections comprise, by way of example, a total extension of approximately y=70 mm each and a half opening or cone angle x of approximately 25°. The cylinder section 73 arranged between the lateral end sections 61, 59 comprises a longitudinal extension w of about 260 mm.

FIG. 17 again shows the adjusting device (adjuster) 75 in detail. The latching recesses 79 are arranged in the plate 77 in accordance with a pivoting movement of the deflection shaft 57 and are evenly distributed along a circular arc line. In this case, the two outer latching recesses 79 define a lower end position of the deflection shaft 57 and an upper end position of the deflection shaft 57. The angle a formed between the end positions, relative to the pivot axis S, can be up to 180° and is, for example, a 130° according to FIG. 17. A maximum outer diameter q of the lateral end sections 61, 63 is approximately 120 mm.

In FIGS. 18 and 19, which show the funnel 3 according to the further exemplary embodiment of the packaging material production machine according to the disclosure of FIGS. 15-25, a discharge opening 91 is shown which is arranged in the feed funnel 3 at the rear, downstream of the conveying direction, and which according to the exemplary embodiments has an angular, in particular rectangular cross-section. It should be clear, however, that also, for example, a round, oval or similar cross-section can be provided, which is selected, for example, as a function of a cross-section of the feed funnel 3. In FIG. 19, the dimensions of the discharge opening 91 are shown schematically, wherein a width s considered transversely to the conveying direction F is in the range of 20 mm to 400 mm, in particular at about 150 mm, and a height r dimensioned substantially in the vertical direction V is in the range of 20 mm to 300 mm, for example at 120 mm.

FIGS. 20 to 25 show exemplary arrangements 100 of packaging material production machines 1 according to the disclosure and at least one packaging material supply in stack form 5 or in roll form 6. According to FIGS. 20-25, the packaging material supply is, in contrast to the preceding embodiments, a web of packaging material rolled up into a roll 6, the roll 6 being configured in such a way that it can be pulled off from a hollow inner side 8. This results in a tubular packaging material strand 40 downstream of the packaging material roll 6 in the conveying direction, which is fed to the packaging material production machine 1.

FIG. 20 shows an embodiment of an arrangement 100 in which the tubular packaging material strand 40 is fed into the feed funnel 3 in a straight line and centrally in the planar projection, in particular top view. A feed direction Z outside the packaging material production machine 1 from the packaging material web roll 6 towards the deflection shaft 57 is oriented parallel or coaxial to the feed direction F inside the packaging material production machine 1 in the planar projection.

In the arrangement 100 according to FIG. 21, an angle 105 is formed between the feed direction Z, in the planar projection or top view according to FIG. 21, and the feed direction F within the packaging material production machine 1. The angle 105 and/or the lateral offset of the packaging material web roll 6 with respect to the packaging material production machine 1 can be flexibly selected. The lateral end sections 59, 61 reliably guide the tubular packaging material strand 40 into the interior of the feed funnel 3 in a centered manner due to their truncated cone shape.

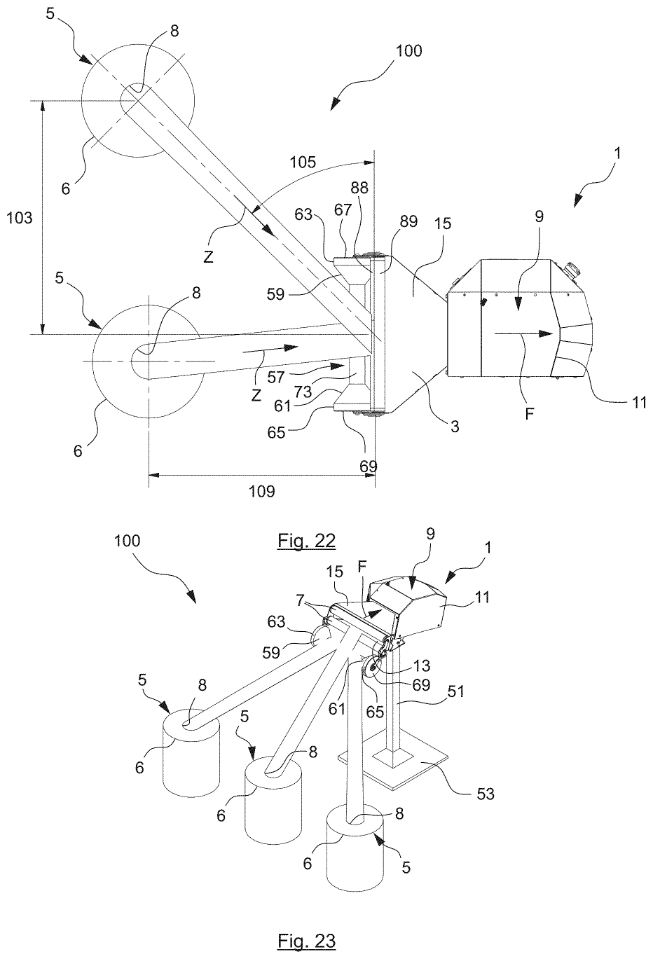

FIGS. 22 to 25 show arrangements of a packaging material production machine 1 with 2 and 3 packaging material web rolls 6, respectively, each of which can be positioned as desired with respect to the packaging material production machine 1. In particular, it is apparent from FIG. 23 that the frustoconical lateral end portions 59, 61 can continue to reliably feed the strand-shaped packaging material 40 into the feed funnel 3 even with the packaging material supply web rolls 6 arranged in a significantly offset manner with respect to the packaging material production machine 1. Furthermore, it can be seen that the positioning of the packaging material web rolls 6 can be reacted to via the adjusting device 75. FIG. 24 represents a schematic top view of the schematic perspective view according to FIG. 23. The corresponding angles and distances of the respective packaging material web rolls 6 with respect to the conveying direction F within the packaging material production machine 1 are again indicated.

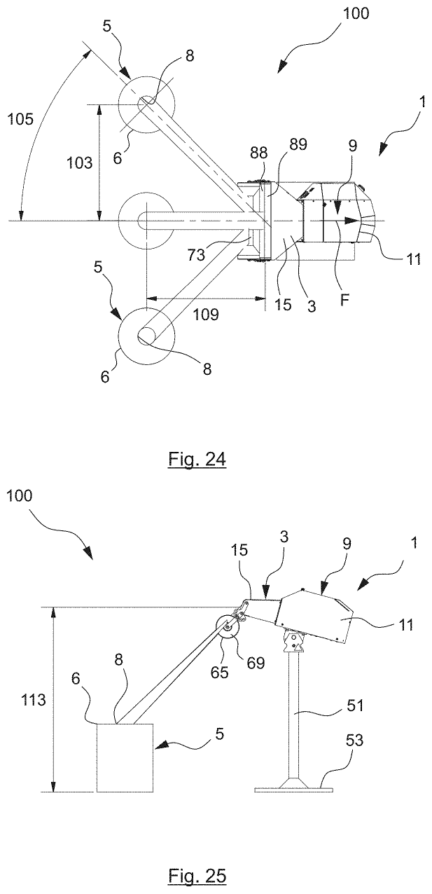

FIG. 25 shows a corresponding schematic side view of the system according to the disclosure. From this, it can be seen that the fed tubular packaging material 40 continuously reduces in its dimension, in particular in diameter, starting from the packaging material web roll 6 to the deflection shaft 57, which is a consequence of the small gap dimension e of the feed opening 13.

The features disclosed in the foregoing description, figures, and claims may be significant both individually and in any combination for the realization of the disclosure in the various embodiments.

To enable those skilled in the art to better understand the solution of the present disclosure, the technical solution in the embodiments of the present disclosure is described clearly and completely below in conjunction with the drawings in the embodiments of the present disclosure.

Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

It should be noted that the terms “first”, “second”, etc. in the description, claims and abovementioned drawings of the present disclosure are used to distinguish between similar objects, but not necessarily used to describe a specific order or sequence. It should be understood that data used in this way can be interchanged as appropriate so that the embodiments of the present disclosure described here can be implemented in an order other than those shown or described here. In addition, the terms “comprise” and “have” and any variants thereof are intended to cover non-exclusive inclusion. For example, a process, method, system, product or equipment comprising a series of steps or modules or units is not necessarily limited to those steps or modules or units which are clearly listed, but may comprise other steps or modules or units which are not clearly listed or are intrinsic to such processes, methods, products or equipment.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

### Reference List

1 packaging material production machine

3 feed funnel

5 packaging material stock

6 packaging material web roll

7 deflection rod

8 inside of roller

9 packaging material processing equipment

10 deflection device (deflector)

11 housing

13 feed opening

15, 17, 19, 21 chute wall

23 mounting plate

25 mounting

27 groove

29 abutting edge

31 engagement element

33 bending point

35 actuating switch

37 packaging material web

39 packaging material supply stack top

40 tubular packaging material strand

41 upper folder

43, 45, 47, 49 packaging material folding sheets

51 stand

53 floor support

57 deflection shaft

59, 61 lateral end section

63, 65 cylinder section

67, 69 face

71 storage opening

72 bearing bolt

73 shaft section

75 adjustment device (adjuster)

77 plate

79 latching recess

81 bolt

83 latching projection

85 connecting part

87 bearing bolt

89, 88 insertion rod

91 dispensing opening

100 arrangement

103 distance

105, 107 angle

113 vertical height

111 substrate

109 horizontal distance

1 radius of curvature of the deflection rod

c length of the feed funnel

d vertical height of the feed funnel

e feed opening height

z total longitudinal extension of the deflection shaft

y total longitudinal extension of the end sections

x half opening angle

w total longitudinal extension of the shaft section

α angle of the swivel movement

q maximum outer diameter of the end sections

a, b diameter of the insertion rods

h angle of the shaft

f funnel angle

r height of the discharge opening

s width of the discharge opening

F conveying direction

Z feed direction

L longitudinal web direction

R rotation axis

S swivel axis

1. A packaging material production machine for manufacturing a packaging material product, comprising:
a feed funnel configured to introduce packaging material from a web-shaped packaging material supply provided into the packaging material production machine; and
a deflection shaft mounted in a free-wheeling manner on the packaging material production machine and configured to introduce the packaging material into the feed funnel, the deflection shaft including lateral end sections whose diameters increase continuously outwardly at least in portions.

2. The packaging material production machine according to claim 1, wherein the lateral end sections are formed frustoconical at least in sections or each have a peripheral surface curved, wherein the frustoconical end sections have a cone angle in the range from 2° to 178°.

3. The packaging material production machine according to claim 1, wherein:
the deflection shaft has a length in the range of 150 mm to 1000 mm;
the lateral end sections have a length in the range of 5 mm to 250 min; and/or
the packing material further comprises a cylinder section connecting the lateral end sections has a length in the range of 140 mm to 990 mm.

4. The packaging material production machine according to claim 1, wherein the deflection shaft is positioned upstream of the feed funnel in a feed direction and/or is mounted on the feed funnel in a height-adjustable manner, a position of the deflection shaft being adjustable with respect to a feed opening of the feed funnel.

5. The packaging material production machine according to claim 1, comprising an adjuster configured to:
attach the deflection shaft to the feed funnel, and
displace the deflection shaft relative to the feed funnel.

6. The packaging material production machine according to claim 5, wherein the adjuster is configured as a pivoting mechanism and to: permit a pivoting movement of up to 180°, and/or pivot the deflection shaft between a lower end position, in which an axis of rotation of the deflection shaft is arranged below a pivot axis of the pivoting mechanism, and an upper end position, in which the axis of rotation of the deflection shaft is arranged above the pivot axis of the pivoting mechanism.

7. The packaging material production machine according to claim 5, wherein the adjuster includes a latch that defines at least two predefined latching positions for the deflection shaft in which the deflection shaft is configured to be releasably fixed.

8. The packaging material production machine according to claim 5, wherein the adjuster defines at least two fixing positions for the deflection shaft in which the deflection shaft us configured to be fixed in a releasable frictionally engaged manner.

9. The packaging material production machine according to claim 7, wherein the latch comprises at least two feed funnel-side latching elements and at least one deflection shaft-side latching member, which are configured to releasably engage with the latching elements to fix the deflection shaft in a latching position.

10. The packaging material production machine according to claim 1, wherein a feed opening of the feed funnel includes an opening height, oriented transversely to a feed direction of the packaging material.

11. The packaging material production machine according to claim 1, wherein a feed opening of the feed funnel is delimited by two feed rods arranged at a distance from one another and mounted on the feed funnel.

12. A packaging material production machine for manufacturing a packaging material product, comprising:
a feed funnel configured to introduce packaging material from a web-shaped packaging material supply provided into the packaging material production machine; and
a deflection rod configured to introduce the packaging material into the feed funnel, the deflection bar having constant cross-section and being curved along its longitudinal extension away from the feed funnel.

13. The packaging material production machine according to claim 11, wherein: the deflection rod has a circular arc shape, and/or a center of curvature of the deflection rod is located downstream of the feed funnel in a feed direction.

14. The packaging material production machine according to claim 11, wherein the deflection rod has an angle of curvature of 20° to 175°, and/or the deflection rod is stationary and/or immovably attached to the feed funnel.

15. The packaging material production machine according to claim 11, wherein:
the packaging material production machine comprises a pair of identically shaped and/or oriented deflection rods that are configured to delimit a feed opening of the feed funnel; and
the feed opening has an opening height, oriented transversely to the feed direction of the packaging material.

16. The packaging material production machine according to claim 11, wherein the feed funnel is configured to form a chute;
having a rectangular inner cross-section that continuously tapers from a feed opening in a direction of a discharge opening at least in sections; and/or
having circumferential chute walls configured to guide the packaging material to the discharge opening.

17. The packaging material production machine according to claim 11, further comprising a packaging material processing device releasably connected to the feed funnel in a form-fitting manner, wherein the packaging material processing device being configured to perform form, emboss and/or separate the packaging material.

18. A deflection device for introducing packaging material from a web-shaped supply of packaging material provided into a packaging material production machine, comprising:
a deflection shaft mounted in a free-wheeling manner, and having lateral end sections, wherein diameters of the lateral end sections increase continuously outwards at least in section; or
a deflection rod having a substantially constant cross-section and being curved along its longitudinal extent in a shape of an arc of a circle.

19. The packaging material production machine according to claim 1, wherein the web-shaped packaging material supply is a leporello stack or in roll form.
